(19) United States
(12) Patent Application Publication
(10) Pub. No.: US 2013/0182776 A1
(43) Pub. Date: Jul. 18, 2013

(54) Video Encoding Using Block-Based Mixed-Resolution Data Pruning

(71) Applicant: Dong-Qing Zhang, Bridgewater, NJ (US)

(72) Inventor: Dong-Qing Zhang, Bridgewater, NJ (US)

(73) Assignee: THOMSON LICENSING, Issy de Moulineaux (FR)

(21) Appl. No.: 13/821,270

(22) PCT Filed: Sep. 9, 2011
(86) PCT No.: PCT/US11/50919

§ 371 Date: Mar. 7, 2013

(30) Foreign Application Priority Data
Sep. 10, 2010 (US) 61403087

(51) Int. Cl. H04N 7/26

(52) U.S. Cl. CPC H04N 19/00945
USPC 375/240.24

(57) ABSTRACT

Method and apparatus are provided for encoding a picture in a video sequence. An apparatus includes a pruning block identifier for identifying one or more original blocks to be pruned from an original version of the picture. The apparatus further includes a block replacer for generating a pruned version of the picture by respectively generating one or more replacement blocks for the one or more original blocks to be pruned. The apparatus also includes a metadata generator for generating metadata for recovering the pruned version of the picture. The metadata includes position information of the one or more replacement blocks. The apparatus additionally includes an encoder for encoding the pruned version of the picture and the metadata.

This application claims the benefit of U.S. Provisional Application Ser. No. 61/403087 entitled BLOCK-BASED MIXED-RESOLUTION DATA PRUNING FOR IMPROVING VIDEO COMPRESSION EFFICIENCY filed on Sep. 10, 2010 (Technicolor Docket No. PU100194).

This application is related to the following co-pending, commonly-owned, patent applications:
(1) International (PCT) Patent Application Serial No. PCT/US11/000107 entitled A SAMPLING-BASED SUPER-RESOLUTION APPROACH FOR EFFICIENT VIDEO COMPRESSION filed on Jan. 20, 2011 (Technicolor Docket No. PU100004);
(2) International (PCT) Patent Application Serial No. PCT/US11/000117 entitled DATA PRUNING FOR VIDEO COMPRESSION USING EXAMPLE-BASED SUPER-RESOLUTION filed on Jan. 21, 2011 (Technicolor Docket No. PU100014);
(3) International (PCT) patent application Ser. No. ______ entitled METHODS AND APPARATUS FOR ENCODING VIDEO SIGNALS USING MOTION COMPENSATED EXAMPLE-BASED SUPER-RESOLUTION FOR VIDEO COMPRESSION filed on Sep. ______, 2011 (Technicolor Docket No. PU100190);
(4) International (PCT) patent application Ser. No. ______ entitled METHODS AND APPARATUS FOR DECODING VIDEO SIGNALS USING MOTION COMPENSATED EXAMPLE-BASED SUPER-RESOLUTION FOR VIDEO COMPRESSION filed on Sep. ______, 2011 (Technicolor Docket No. PU100266);
(5) International (PCT) patent application Ser. No. ______ entitled METHODS AND APPARATUS FOR ENCODING VIDEO SIGNALS USING EXAMPLE-BASED DATA PRUNING FOR IMPROVED VIDEO COMPRESSION EFFICIENCY filed on Sep. ______, 2011 (Technicolor Docket No. PU100193);
(6) International (PCT) patent application Ser. No. ______ entitled METHODS AND APPARATUS FOR DECODING VIDEO SIGNALS USING EXAMPLE-BASED DATA PRUNING FOR IMPROVED VIDEO COMPRESSION EFFICIENCY filed on Sept. ______, 2011 (Technicolor Docket No. PU100267);
(7) International (PCT) patent application Ser. No. ______ entitled METHODS AND APPARATUS FOR DECODING VIDEO SIGNALS FOR BLOCK-BASED MIXED-RESOLUTION DATA PRUNING filed on Sep. ______, 2011 (Technicolor Docket No. PU100268);
(8) International (PCT) patent application Ser. No. ______entitled METHODS AND APPARATUS FOR EFFICIENT REFERENCE DATA ENCODING FOR VIDEO COMPRESSION BY IMAGE CONTENT BASED SEARCH AND RANKING filed on Sep. ______, 2011 (Technicolor Docket No. PU100195);
(9) International (PCT) patent application Ser. No. ______ entitled METHOD AND APPARATUS FOR EFFICIENT REFERENCE DATA DECODING FOR VIDEO COMPRESSION BY IMAGE CONTENT BASED SEARCH AND RANKING filed on Sep. ______, 2011 (Technicolor Docket No. PU110106);
(10) International (PCT) patent application Ser. No. ______ entitled METHOD AND APPARATUS FOR ENCODING VIDEO SIGNALS FOR EXAMPLE-BASED DATA PRUNING USING INTRA-FRAME PATCH SIMILARITY filed on Sep. ______, 2011 (Technicolor Docket No. PU100196);
(11) International (PCT) patent application Ser. No. ______ entitled METHOD AND APPARATUS FOR DECODING VIDEO SIGNALS WITH EXAMPLE-BASED DATA PRUNING USING INTRA-FRAME PATCH SIMILARITY filed on Sep. ______, 2011 (Technicolor Docket No. PU100269); and
(12) International (PCT) patent application Ser. No. ______ entitled PRUNING DECISION OPTIMIZATION IN EXAMPLE-BASED DATA PRUNING COMPRESSION filed on Sep. ______, 2011 (Technicolor Docket No. PU10197).

The present principles relate generally to video encoding and decoding and, more particularly, to methods and apparatus for block-based mixed-resolution data pruning for improving video compression efficiency.

There have been several different approaches for data pruning to improve video coding efficiency. For example, a first approach is vertical and horizontal line removal. The first approach removes vertical and horizontal lines in video frames before encoding, and recovers the lines by non-linear interpolation after decoding. Which line is removed is determined by whether or not the line includes high-frequency signal. The problem of the first approach is that the first approach lacks the flexibility to selectively remove pixels. That is, the first approach may remove a line including important pixels that could not be easily recovered although overall the line includes a small amount of signal having a high-frequency.

Another category of approach with respect to the aforementioned first approach is based on block removal, which removes and recovers blocks rather than lines. However, the other category of approach uses in-loop methods, meaning that the encoder architecture has to be modified to accommodate the block removal. Therefore, the other category of approach is not strictly a pre-processing based approach, since the encoder has to be modified.

These and other drawbacks and disadvantages of these approaches are addressed by the present principles, which are directed to methods and apparatus for block-based mixed-resolution data pruning for improving video compression efficiency.

According to an aspect of the present principles, there is provided an apparatus for encoding a picture in a video sequence. The apparatus includes a pruning block identifier for identifying one or more original blocks to be pruned from an original version of the picture. The apparatus further includes a block replacer for generating a pruned version of the picture by respectively generating one or more replacement blocks for the one or more original blocks to be pruned. The apparatus also includes a metadata generator for generating metadata for recovering the pruned version of the picture. The metadata includes position information of the one or more replacement blocks. The apparatus additionally includes an encoder for encoding the pruned version of the picture and the metadata.

According to another aspect of the present principles, there is provided a method for encoding a picture in a video sequence. The method includes identifying one or more original blocks to be pruned from an original version of the picture. The method further includes generating a pruned version of the picture by respectively generating one or more replacement blocks for the one or more original blocks to be pruned. The method also includes generating metadata for recovering the pruned version of the picture. The metadata includes position information of the one or more replacement blocks. The method additionally includes encoding the pruned version of the picture and the metadata using at least one encoder.

According to yet another aspect of the present principles, there is provided an apparatus for recovering a pruned version of a picture in a video sequence. The apparatus includes a pruned block identifier for identifying one or more pruned blocks in the pruned version of the picture. The apparatus further includes a metadata decoder for decoding metadata for recovering the pruned version of the picture. The metadata includes position information of the one or more replacement blocks. The apparatus also includes a block restorer for respectively generating one or more replacement blocks for the one or more pruned blocks.

According to a further aspect of the present principles, there is provided a method for recovering a pruned version of a picture in a video sequence. The method includes identifying one or more pruned blocks in the pruned version of the picture. The method further includes decoding metadata for recovering the pruned version of the picture using a decoder. The metadata includes position information of the one or more replacement blocks. The method also includes respectively generating one or more replacement blocks for the one or more pruned blocks.

According to an additional aspect of the present principles, there is provided an apparatus for encoding a picture in a video sequence. The apparatus includes means for identifying one or more original blocks to be pruned from an original version of the picture. The apparatus further includes means for generating a pruned version of the picture by respectively generating one or more replacement blocks for the one or more original blocks to be pruned. The apparatus also includes means for generating metadata for recovering the pruned version of the picture. The metadata includes position information of the one or more replacement blocks. The apparatus additionally includes means for encoding the pruned version of the picture and the metadata.

According to a yet additional aspect of the present principles, there is provided an apparatus for recovering a pruned version of a picture in a video sequence. The apparatus includes means for identifying one or more pruned blocks in the pruned version of the picture. The apparatus further includes means for decoding metadata for recovering the pruned version of the picture. The metadata includes position information of the one or more replacement blocks. The apparatus also includes means for respectively generating one or more replacement blocks for the one or more pruned blocks.

These and other aspects, features and advantages of the present principles will become apparent from the following detailed description of exemplary embodiments, which is to be read in connection with the accompanying drawings.

The present principles may be better understood in accordance with the following exemplary figures, in which:

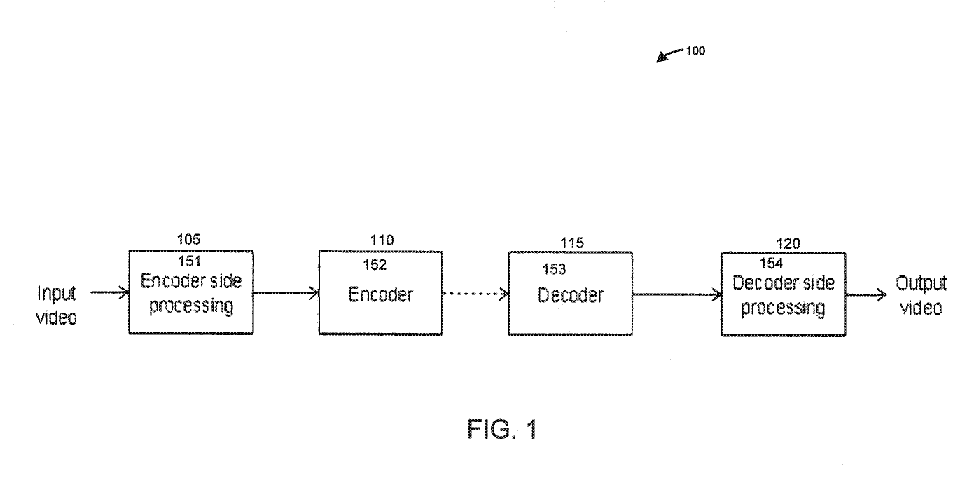

FIG. 1 is a block diagram showing a high level block diagram of an block-based mixed-resolution data pruning system/method, in accordance with an embodiment of the present principles;

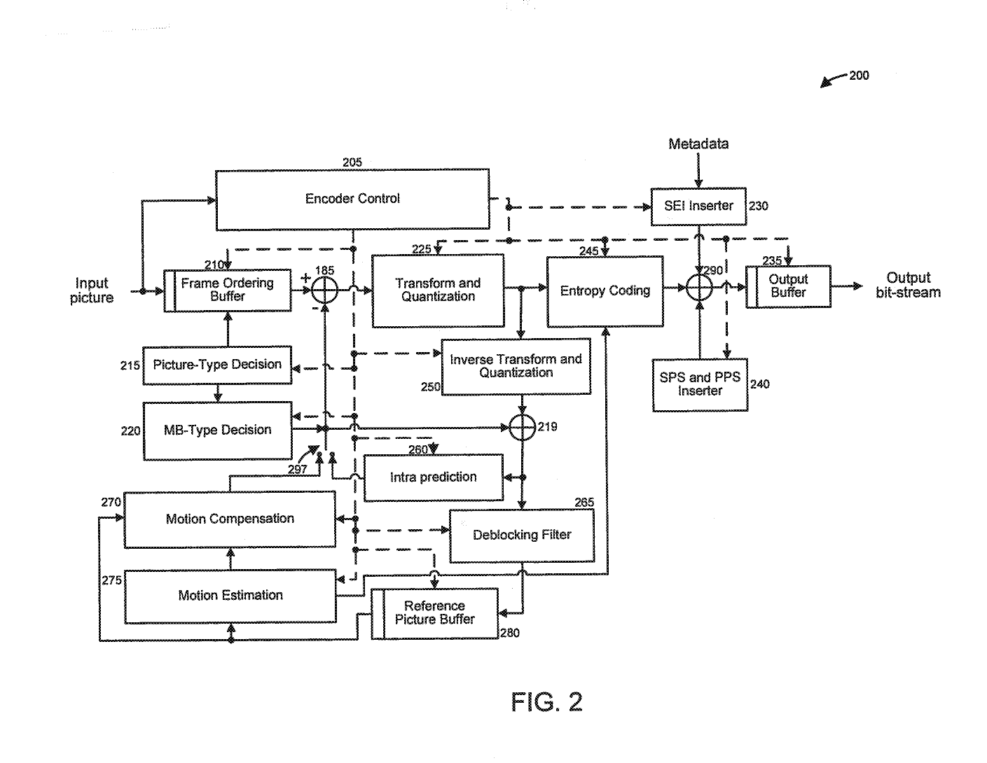

FIG. 2 is a block diagram showing an exemplary video encoder to which the present principles may be applied, in accordance with an embodiment of the present principles;

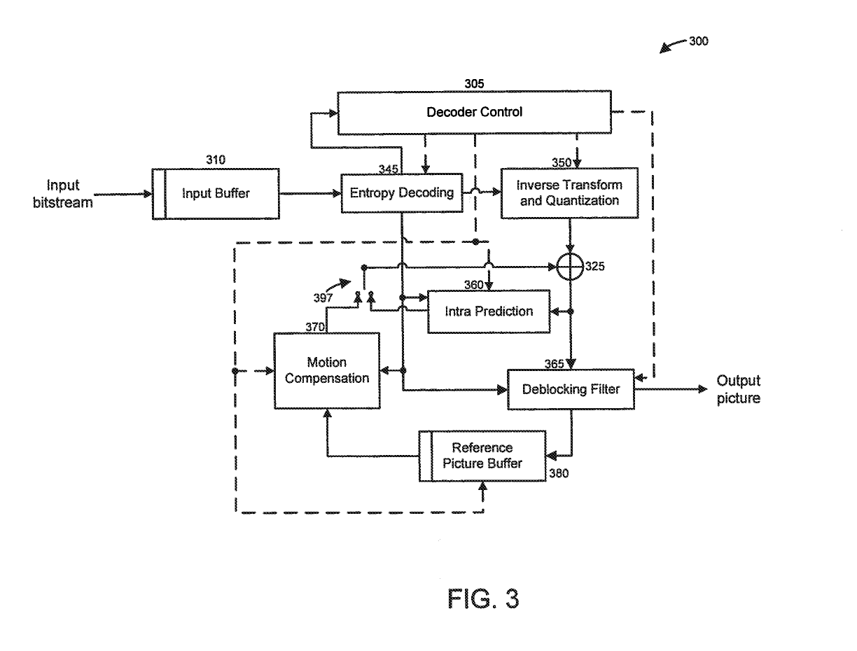

FIG. 3 is a block diagram showing an exemplary video decoder to which the present principles may be applied, in accordance with an embodiment of the present principles;

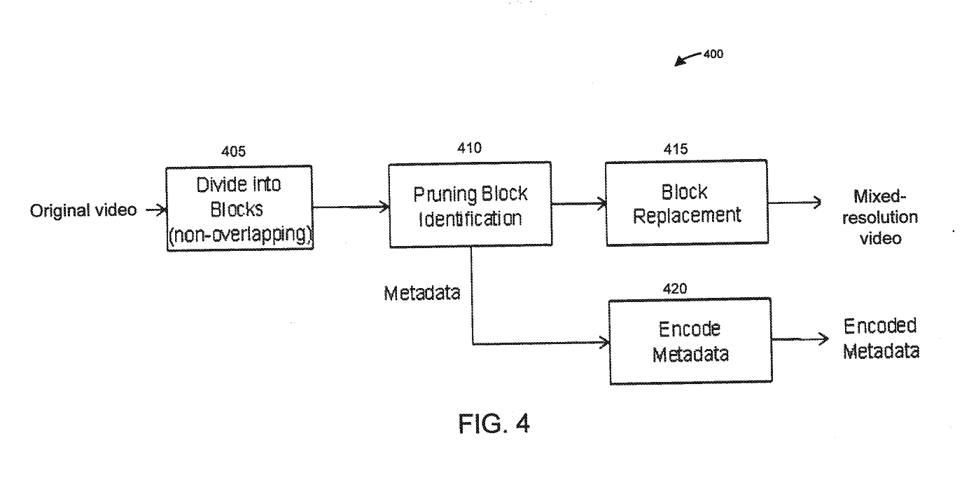

FIG. 4 is a block diagram showing an exemplary system for block-based mixed-resolution data pruning, in accordance with an embodiment of the present principles;

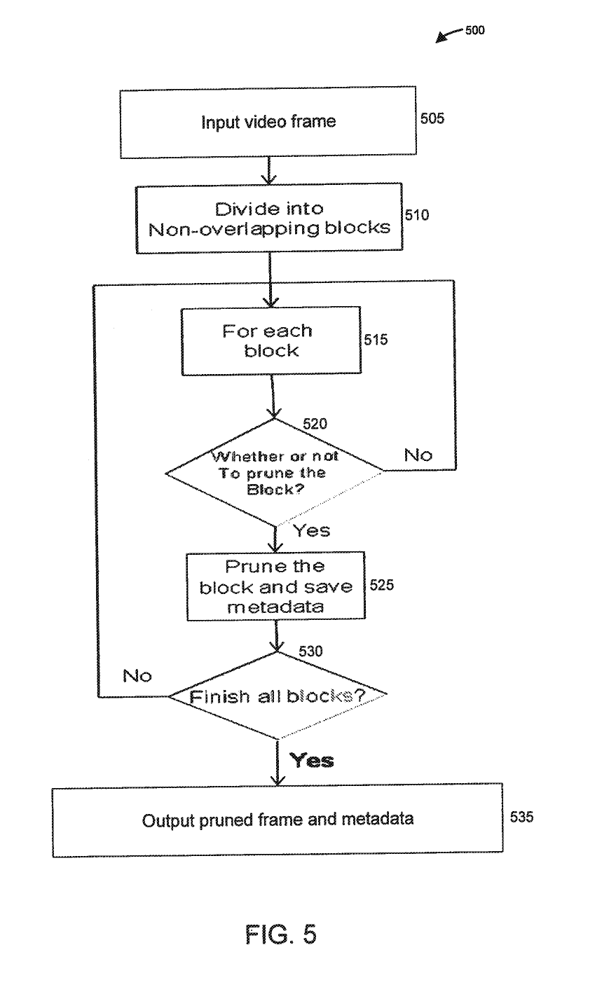

FIG. 5 is a flow diagram showing an exemplary method for block-based mixed-resolution data pruning for video compression, in accordance with an embodiment of the present principles;

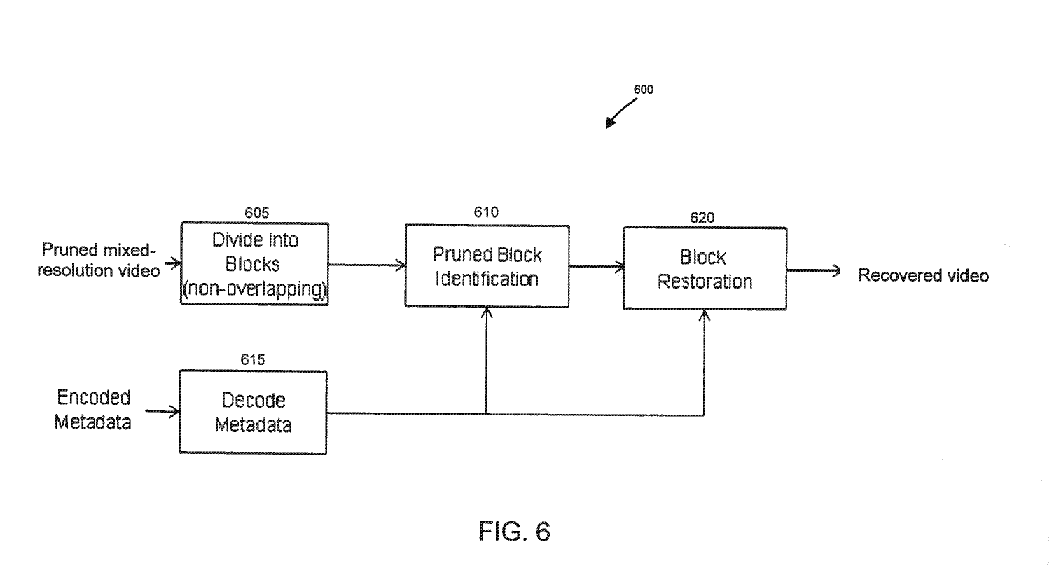

FIG. 6 is a block diagram showing an exemplary system for data recovery for block-based mixed-resolution data pruning, in accordance with an embodiment of the present principles;

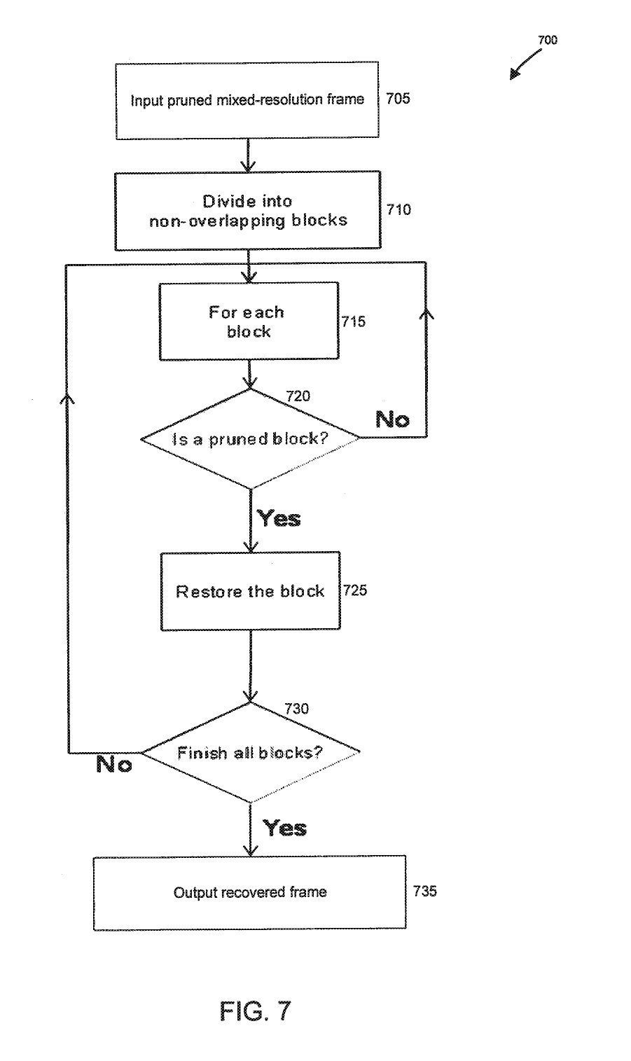

FIG. 7 is a flow diagram showing an exemplary method for data recovery for block-based mixed-resolution data pruning for video compression, in accordance with an embodiment of the present principles;

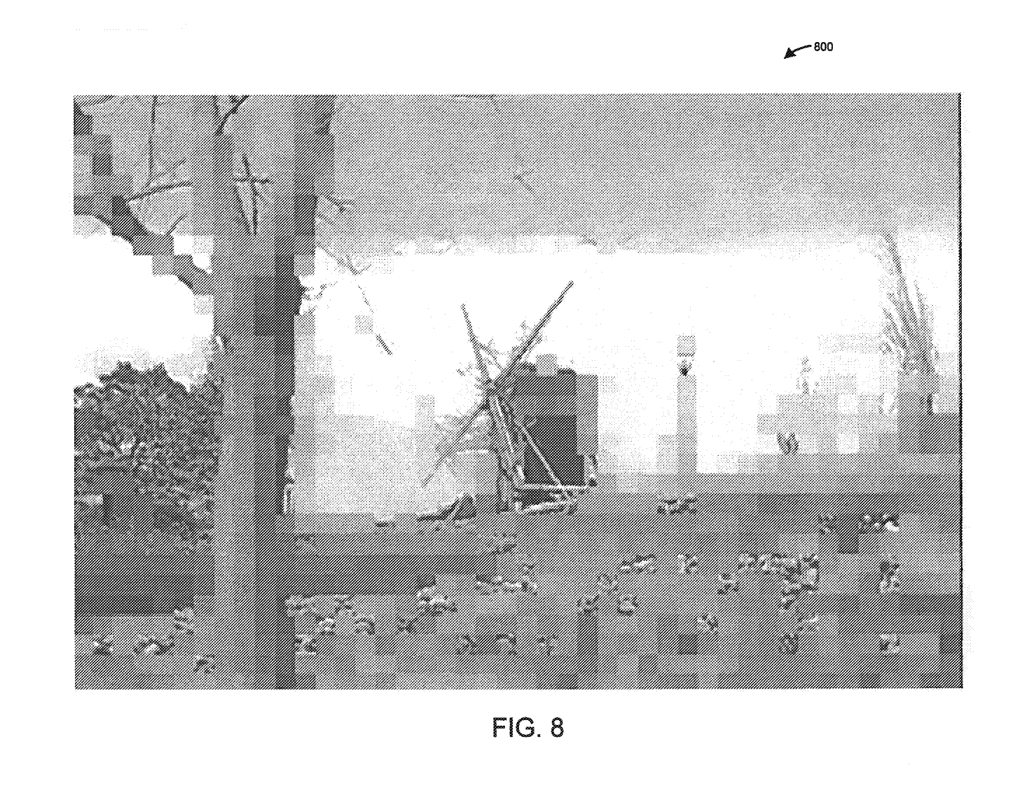

FIG. 8 is a diagram showing an exemplary mixed-resolution frame, in accordance with an embodiment of the present principles;

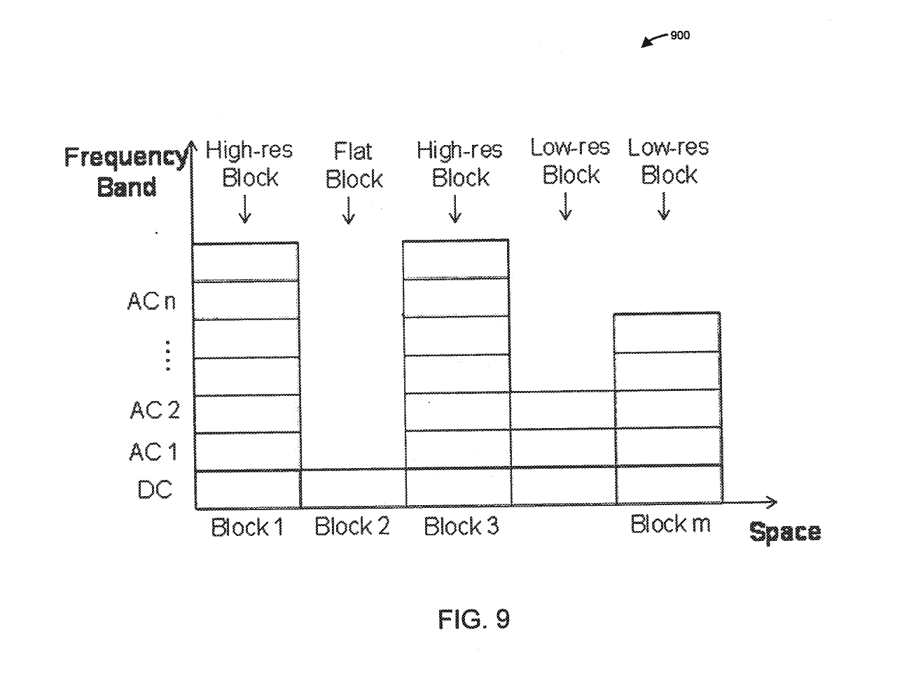

FIG. 9 is a diagram showing an example of the block-based mixed-resolution data pruning process shown in spatio-frequency space, in accordance with an embodiment of the present principles;

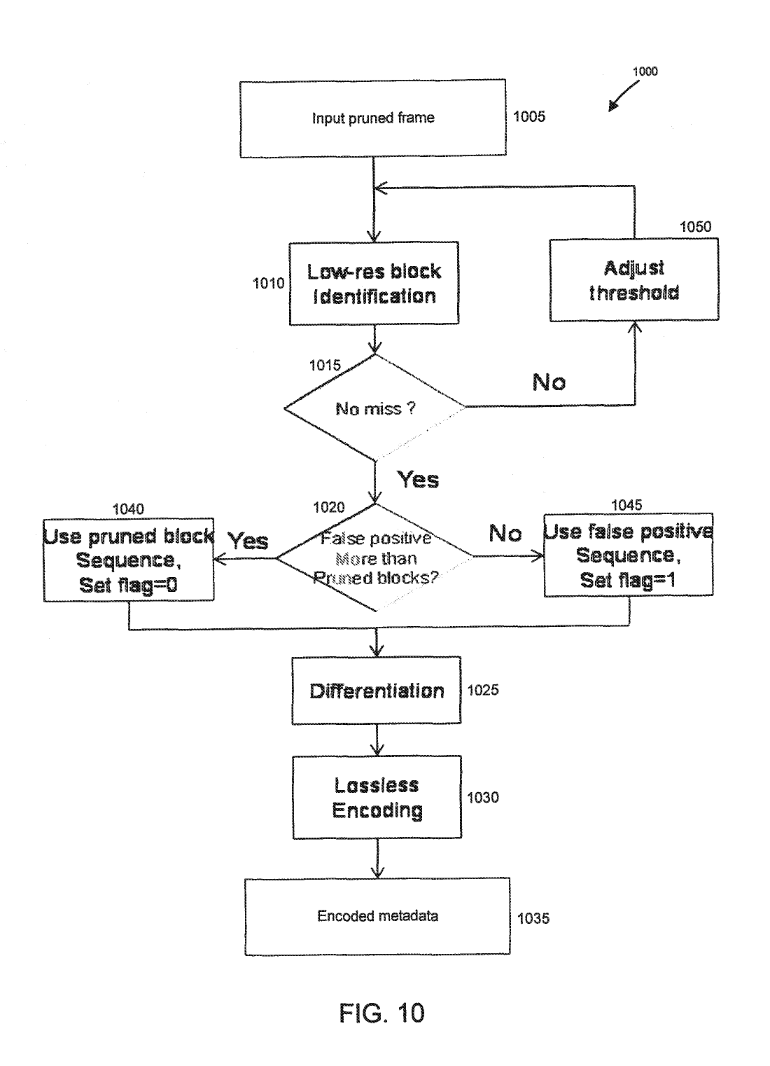

FIG. 10 is a flow diagram showing an exemplary method for metadata encoding, in accordance with an embodiment of the present principles;

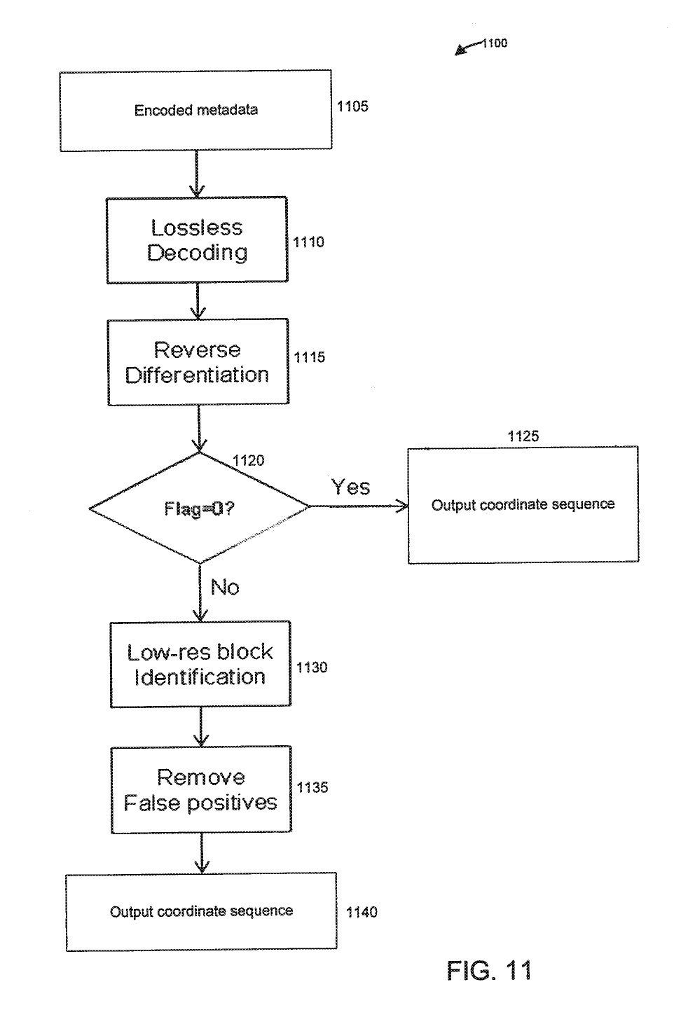

FIG. 11 is a flow diagram showing an exemplary method for metadata decoding, in accordance with an embodiment of the present principles; and

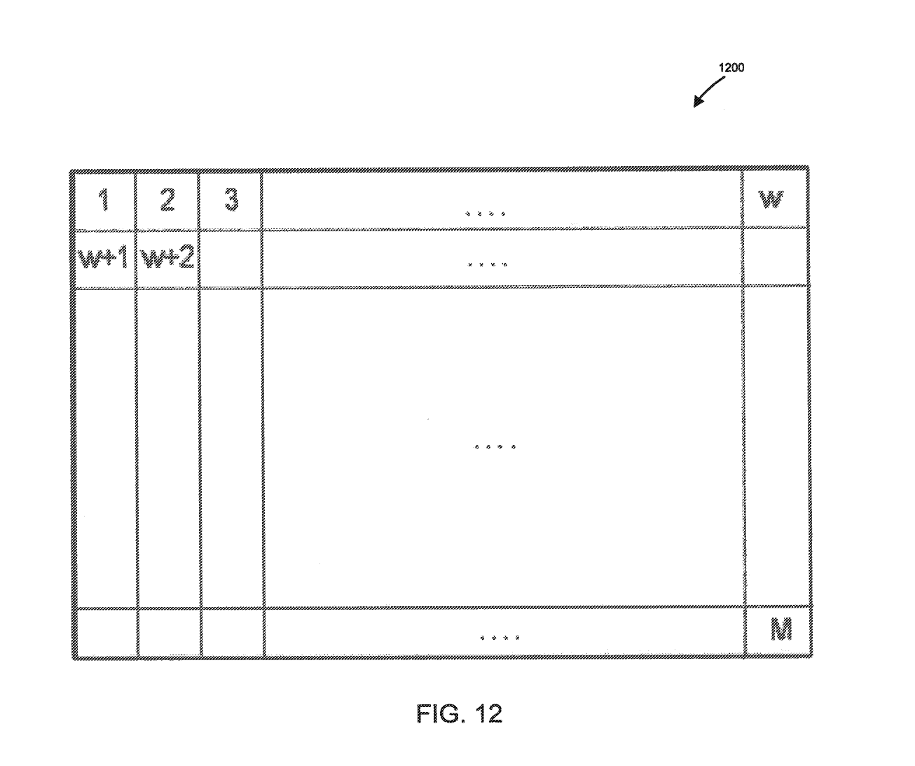

FIG. 12 is a diagram showing an exemplary block ID, in accordance with an embodiment of the present principles.

The present principles are directed to methods and apparatus for block-based mixed-resolution data pruning for improving video compression efficiency.

The present description illustrates the present principles. It will thus be appreciated that those skilled in the art will be able to devise various arrangements that, although not explicitly described or shown herein, embody the present principles and are included within its spirit and scope.

All examples and conditional language recited herein are intended for pedagogical purposes to aid the reader in understanding the present principles and the concepts contributed by the inventor(s) to furthering the art, and are to be construed as being without limitation to such specifically recited examples and conditions.

Moreover, all statements herein reciting principles, aspects, and embodiments of the present principles, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that the block diagrams presented herein represent conceptual views of illustrative circuitry embodying the present principles. Similarly, it will be appreciated that any flow charts, flow diagrams, state transition diagrams, pseudocode, and the like represent various processes which may be substantially represented in computer readable media and so executed by a computer or processor, whether or not such computer or processor is explicitly shown.

The functions of the various elements shown in the figures may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (“DSP”) hardware, read-only memory (“ROM”) for storing software, random access memory (“RAM”), and non-volatile storage.

Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

In the claims hereof, any element expressed as a means for performing a specified function is intended to encompass any way of performing that function including, for example, a) a combination of circuit elements that performs that function or b) software in any form, including, therefore, firmware, microcode or the like, combined with appropriate circuitry for executing that software to perform the function. The present principles as defined by such claims reside in the fact that the functionalities provided by the various recited means are combined and brought together in the manner which the claims call for. It is thus regarded that any means that can provide those functionalities are equivalent to those shown herein.

Reference in the specification to “one embodiment” or “an embodiment” of the present principles, as well as other variations thereof, means that a particular feature, structure, characteristic, and so forth described in connection with the embodiment is included in at least one embodiment of the present principles. Thus, the appearances of the phrase “in one embodiment” or “in an embodiment”, as well any other variations, appearing in various places throughout the specification are not necessarily all referring to the same embodiment.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as readily apparent by one of ordinary skill in this and related arts, for as many items listed.

Also, as used herein, the words “picture” and “image” are used interchangeably and refer to a still image or a picture from a video sequence. As is known, a picture may be a frame or a field.

Additionally, it is to be appreciated that the words “recovery” and “restoration” are used interchangeably herein.

As noted above, the present principles are directed to block-based mixed-resolution data pruning for improving video compression efficiency. Data pruning is a video preprocessing technique to achieve better video coding efficiency by removing part of the input video data before the input video data is encoded. The removed video data is recovered at the decoder side by inferring from the decoded data. One example of data pruning is image line removal, which removes some of the horizontal and vertical scan lines in the input video.

A framework for a mixed-resolution data pruning scheme to prune a video is disclosed in accordance with the present principles, where the high-resolution (high-res) blocks in a video are replaced by low-resolution (low-res) blocks or flat blocks. Also disclosed in accordance with the present principles is a metadata encoding scheme that encodes the positions of the pruned blocks, which uses a combination of image processing techniques and entropy coding.

In accordance with an embodiment of the present principles, a video frame is divided into non-overlapping blocks, and some of the blocks are replaced with low-resolution blocks or simply flat blocks. The pruned video is then sent to a video encoder for compression. The pruning process should result in more efficient video encoding, because some blocks in the video frames are replaced with low-res or flat blocks, which have less high-frequency signal. The replaced blocks can be recovered by various existing algorithms, such as inpainting, texture synthesis, and so forth. In accordance with the present principles, we disclose how to encode and send the metadata needed for the recovery process.

Different from the aforementioned other category of approach to data pruning to improve video compression, the present principles provide a strictly out-of-loop approach in which the encoder and decoder are kept intact and treated as black boxes and can be replaced by any encoding (and decoding) standard or implementation. The advantage of such an out-of-loop approach is that users do not need to change the encoding and decoding workflow, which might not be feasible in certain circumstances.

Turning to FIG. 1, a high level block diagram of a block-based mixed-resolution data pruning system/method is indicated generally by the reference numeral 100. Input video is provided and subjected to encoder side pre-processing at step 110 (by an encoder side pre-processor 151) in order to obtain pre-processed frames. The pre-processed frames are encoded (by an encoder 152) at step 115. The encoded frames are decoded (by a decoder 153) at step 120. The decoded frames are subjected to post-processing (by a decoder side post-processor 154) in order to provide output video at step 125.

The data pruning processing is performed in the encoder side pre-processor 151. The pruned video is sent to the encoder 152 afterwards. The encoded video along with the metadata needed for recovery are then sent to the decoder 153. The decoder 153 decompresses the pruned video, and the decoder side post-processor 154 recovers the original video from the pruned video with or without the received metadata (as in some circumstances it is possible that the metadata is not needed and, hence, used, for the recovery).

Turning to FIG. 2, an exemplary video encoder to which the present principles may be applied is indicated generally by the reference numeral 200. The video encoder 200 may be used, for example, as video encoder 152 shown in FIG. 1. The video encoder 200 includes a frame ordering buffer 210 having an output in signal communication with a non-inverting input of a combiner 285. An output of the combiner 285 is connected in signal communication with a first input of a transformer and quantizer 225. An output of the transformer and quantizer 225 is connected in signal communication with a first input of an entropy coder 245 and a first input of an inverse transformer and inverse quantizer 250. An output of the entropy coder 245 is connected in signal communication with a first non-inverting input of a combiner 290. An output of the combiner 190 is connected in signal communication with a first input of an output buffer 235.

A first output of an encoder controller 205 is connected in signal communication with a second input of the frame ordering buffer 210, a second input of the inverse transformer and inverse quantizer 250, an input of a picture-type decision module 215, a first input of a macroblock-type (MB-type) decision module 220, a second input of an intra prediction module 260, a second input of a deblocking filter 265, a first input of a motion compensator 270, a first input of a motion estimator 275, and a second input of a reference picture buffer 280.

A second output of the encoder controller 205 is connected in signal communication with a first input of a Supplemental Enhancement Information (SEI) inserter 230, a second input of the transformer and quantizer 225, a second input of the entropy coder 245, a second input of the output buffer 235, and an input of the Sequence Parameter Set (SPS) and Picture

Parameter Set (PPS) inserter 240.

An output of the SEI inserter 230 is connected in signal communication with a second non-inverting input of the combiner 290.

A first output of the picture-type decision module 215 is connected in signal communication with a third input of the frame ordering buffer 210. A second output of the picture-type decision module 215 is connected in signal communication with a second input of a macroblock-type decision module 220.

An output of the Sequence Parameter Set (SPS) and Picture Parameter Set (PPS) inserter 240 is connected in signal communication with a third non-inverting input of the combiner 290.

An output of the inverse quantizer and inverse transformer 250 is connected in signal communication with a first non-inverting input of a combiner 219. An output of the combiner 219 is connected in signal communication with a first input of the intra prediction module 260 and a first input of the deblocking filter 265. An output of the deblocking filter 265 is connected in signal communication with a first input of a reference picture buffer 280. An output of the reference picture buffer 280 is connected in signal communication with a second input of the motion estimator 275 and a third input of the motion compensator 270. A first output of the motion estimator 275 is connected in signal communication with a second input of the motion compensator 270. A second output of the motion estimator 275 is connected in signal communication with a third input of the entropy coder 245.

An output of the motion compensator 270 is connected in signal communication with a first input of a switch 297. An output of the intra prediction module 260 is connected in signal communication with a second input of the switch 297. An output of the macroblock-type decision module 220 is connected in signal communication with a third input of the switch 297. The third input of the switch 297 determines whether or not the “data” input of the switch (as compared to the control input, i.e., the third input) is to be provided by the motion compensator 270 or the intra prediction module 260. The output of the switch 297 is connected in signal communication with a second non-inverting input of the combiner 219 and an inverting input of the combiner 285.

A first input of the frame ordering buffer 210 and an input of the encoder controller 205 are available as inputs of the encoder 200, for receiving an input picture. Moreover, a second input of the Supplemental Enhancement Information (SEI) inserter 230 is available as an input of the encoder 200, for receiving metadata. An output of the output buffer 235 is available as an output of the encoder 200, for outputting a bitstream.

Turning to FIG. 3, an exemplary video decoder to which the present principles may be applied is indicated generally by the reference numeral 300. The video decoder 300 may be used, for example, as video decoder 153 shown in FIG. 1. The video decoder 300 includes an input buffer 310 having an output connected in signal communication with a first input of an entropy decoder 345. A first output of the entropy decoder 345 is connected in signal communication with a first input of an inverse transformer and inverse quantizer 350. An output of the inverse transformer and inverse quantizer 350 is connected in signal communication with a second non-inverting input of a combiner 325. An output of the combiner 325 is connected in signal communication with a second input of a deblocking filter 365 and a first input of an intra prediction module 360. A second output of the deblocking filter 365 is connected in signal communication with a first input of a reference picture buffer 380. An output of the reference picture buffer 380 is connected in signal communication with a second input of a motion compensator 370.

A second output of the entropy decoder 345 is connected in signal communication with a third input of the motion compensator 370, a first input of the deblocking filter 365, and a third input of the intra predictor 360. A third output of the entropy decoder 345 is connected in signal communication with an input of a decoder controller 305. A first output of the decoder controller 305 is connected in signal communication with a second input of the entropy decoder 345. A second output of the decoder controller 305 is connected in signal communication with a second input of the inverse transformer and inverse quantizer 350. A third output of the decoder controller 305 is connected in signal communication with a third input of the deblocking filter 365. A fourth output of the decoder controller 305 is connected in signal communication with a second input of the intra prediction module 360, a first input of the motion compensator 370, and a second input of the reference picture buffer 380.

An output of the motion compensator 370 is connected in signal communication with a first input of a switch 397. An output of the intra prediction module 360 is connected in signal communication with a second input of the switch 397. An output of the switch 397 is connected in signal communication with a first non-inverting input of the combiner 325.

An input of the input buffer 310 is available as an input of the decoder 300, for receiving an input bitstream. A first output of the deblocking filter 365 is available as an output of the decoder 300, for outputting an output picture.

Turning to FIG. 4, an exemplary system for block-based mixed-resolution data pruning is indicated generally by the reference numeral 400. The system 400 includes a divider 405 having an output connected in signal communication with an input of a pruning block identifier 410. A first output of the pruning block identifier 410 is connected in signal communication with an input of a block replacer 415. A second output of the pruning block identifier 410 is connected in signal communication with an input of a metadata encoder 420. An input of the divider 405 is available as an input to the system 400, for receiving an original video for dividing into non-overlapping blocks. An output of the block replacer 415 is available as an output of the system 400, for outputting mixed-resolution video. An output of the metadata encoder is available as an output of the system 400, for outputting encoded metadata.

Turning to FIG. 5, an exemplary method for block-based mixed-resolution data pruning for video compression is indicated generally by the reference numeral 500. At step 505, a video frame is input. At step 510, the video frame is divided into non-overlapping blocks. At step 515, a loop is performed for each block. At step 520, it is determined whether or not to prune a current block. If so, then the method proceeds to step 525. Otherwise, the method returns to step 515. At step 525, the block is pruned and corresponding metadata is saved. At step 530, it is determined whether or not all the blocks have finished (being processed). If so, then control is passed to a function block 535. Otherwise, the method returns to step 515. At step 530, the pruned frame and corresponding metadata are output.

Referring to FIGS. 4 and 5, during the pruning process, the input frames are first divided into non-overlapping blocks. A pruning block identification process is then conducted to identify the recoverable blocks that can be pruned. The coordinates of the pruned blocks are saved as metadata, which will be encoded and sent to the decoder side. The blocks ready for pruning will be replaced with low resolution blocks or simply flat blocks. The result is a video frame with some of the blocks having high resolution, and some of the blocks having low resolution (i.e., a mixed-resolution frame).

Turning to FIG. 6, an exemplary system for data recovery for block-based mixed-resolution data pruning is indicated generally by the reference numeral 600. The system 600 includes a divider 605 having an output connected in signal communication with a first input of a pruned block identifier 610. An output of a metadata decoder 615 is connected in signal communication with a second input of the pruned block identifier 610 and a second input of a block restorer 620. An output of the pruned block identifier 610 is connected in signal communication with a first input of the block restorer 620. An input of the divider 605 is available as an input of the system 600, for receiving a pruned mixed-resolution video for dividing into non-overlapping blocks. An input of the metadata encoder 615 is also available as an input of the system 600, for receiving encoded metadata. An output of the block restorer 620 is available as an output of the system 600, for outputting recovered video.

Turning to FIG. 7, an exemplary method for data recovery for block-based mixed-resolution data pruning for video compression is indicated generally by the reference numeral 700. At step 705, a pruned mixed-resolution frame is input. At step 710, the frame is divided into non-overlapping blocks. At step 715, a loop is performed for each block. At step 720, it is determined whether or not the current block is a pruned block. If so, then the method proceeds to step 725. Otherwise, the method returns to step 715. At step 725, the block is restored. At step 730, it is determined whether or not all the blocks have finished (being processed). If so, then the method proceeds to step 735. Otherwise, the method returns to step 715. At step 735, the recovered frame is output.

Referring to FIGS. 6 and 7, during the recovery process, the pruned blocks are identified with the help of the metadata. Also, the pruned blocks are recovered with a block restoration process with or without the help of the metadata using various algorithms, such as inpainting. The block restoration and identification can be replaced with different plug-in methods, which are not the focus of the present principles. That is, the present principles are not based on any particular block restoration and identification process and, thus, any applicable block restoration and identification process may be used in accordance with the teachings of the present principles, while maintaining the spirit of the present principles.

### Pruning Process

The input video frame is first divided into non-overlapping blocks. The block size can be varied, for example 16 by 16 pixels or 8 by 8 pixels. However, it is desirable that the block division be the same as that used by the encoder so that maximum compression efficiency can be achieved. For example, in encoding in accordance with the International Organization for Standardization/International Electrotechnical Commission (ISO/IEC) Moving Picture Experts Group-4 (MPEG-4) Part 10 Advanced Video Coding (AVC) Standard/International Telecommunication Union, Telecommunication Sector (ITU-T) H.264 Recommendation (hereinafter the “MPEG-4 AVC Standard”), a macroblock is 16 by 16 pixels. Thus, in an embodiment involving the MPEG-4 AVC Standard, the preferred choice of block size for data pruning is 16 by 16 pixels.

For each block, the block identification process will determine whether or not the block should be pruned. This can be based on various criteria, but the criteria should be determined by the restoration process. For example, if the inpainting approach is used to restore the blocks, then the criterion should be whether or not the block can be restored using the particular inpainting process. If the block is recoverable by the inpainting process, then the block is marked as a pruning block.

After the pruning blocks are identified, the pruning blocks will be replaced with low-resolution blocks or flat blocks, resulting in a mixed-resolution frame. Turning to FIG. 8, an exemplary mixed-resolution frame is indicated generally by the reference numeral 800. It can be seen from FIG. 8 that some parts of the frame have high resolution, and some parts of the frame are replaced with flat blocks. The high frequency signal in the low-resolution or flat blocks are removed during the pruning process. Thus, the low-resolution or flat blocks can be more efficiently encoded. Turning to FIG. 9, an example of the block-based mixed-resolution data pruning process shown in spatio-frequency space is indicated generally by the reference numeral 900. The flat block is basically the block where only its DC component is retained, and the low-res blocks are the block where some of the AC components are removed. In practice, if the pruned block is decided to be replaced with a flat block, then first it is possible to compute the average color of the input block, and then the color of all of the pixels within the block is set to the average color. The process is equivalent to only retaining the DC component of the block. If the pruned block is decided to be replaced with a low-res block, a low-pass filter is applied to the input block, and the block is replaced with the low-pass filtered version. Whether using a flat block or a low-res block, the parameters of the low-pass filters shall be determined by what type of restoration algorithm is used.

### Metadata Encoding and Decoding

In order to correctly restore the pruned block for the recovery process, the positions of the blocks, as represented by metadata, have to be sent to the decoder side. One simple approach is to compress the position data using general lossless data compression algorithms. However, for our system, it is possible to achieve better compression efficiency by the fact that the pruned blocks are low-resolution or flat blocks, and the low-res or flat blocks could be identified by detecting whether or not the pruned block includes a high-frequency signal.

Presuming that the maximum frequency of the pruned block is Fm, which is predetermined by the pruning and restoration algorithm, then it is possible to compute the energy of the signal component larger than the maximum frequency Fm. If the energy is smaller than a threshold, then the block is a potential pruned block. This can be achieved by first applying a low-pass filter to the block image, then subtracting the filtered block image from the input block image, followed by computing the energy of the high frequency signal. Mathematically, there is the following:

E=|B−HB| (1)

where E is the energy of the high frequency signal, B is the input block image, H is the low-pass filter having bandwidth Fm, and HB is the low-pass filtered version of B. |.| is a function to compute the energy of an image.

However, the above described process is not one hundred percent reliable, because non-pruned blocks could also be flat or smooth. Therefore, it also necessary to send to the decoder the “residuals”, namely the coordinates of the false positive blocks and the coordinates of the missed blocks by the identification process.

In theory, it is possible to send those 3 components to the decoder side, namely the threshold, the coordinates of the false positive blocks, and the coordinates of the missed blocks. However, for a simpler process, at the encoder side, the threshold may vary, so that all pruned blocks are identified. Thus, there are no missed blocks. This process could result in some false positive blocks, which are non-pruned blocks which have low high-frequency energy. Thus, if the number of the false positive blocks is larger than that of the pruned blocks, then the coordinates of all pruned blocks is just sent and a signaling flag is set as 0. Otherwise, the coordinates of the false positive blocks is sent and the signaling flag is set as 1.

Turning to FIG. 10, an exemplary method for metadata encoding is indicated generally by the reference numeral 1000. At step 1005, a pruned frame is input. At step 1010, a low-res block identification is performed. At step 1015, it is determined whether or not there are any misses in the low-res block identification. If so, then the method proceeds to step 1020. Otherwise, the method proceeds to step 1050. At step 1020, it is determined whether or not there are more false positives than pruned blocks. If so, then the method proceeds to step 1040. Otherwise, the method proceeds to step 1045. At step 1040, the pruned block sequence is used, and a flag is set to zero. At step 1025, a differentiation is performed. At step 1030, lossless encoding is performed. At step 1035, encoded metadata is output. At step 1045, the false positive sequence is used, and a flag is set to one. At step 1050, a threshold is adjusted.

Thus, the following exemplary metadata sequence is provided:

| | | |
|---|---|---|
| Flag | Threshold | Encoded Coordinate Sequence |

The “flag” segment is a binary number that indicates whether the following sequence is the coordinates of the false positive blocks or the pruned blocks. The number “threshold” is used for low-res or flat block identification using Equation (1).

Turning to FIG. 11, an exemplary method for metadata decoding is indicated generally by the reference numeral 1100. At step 1105, encoded metadata is input. At step 1110, lossless decoding is performed. At step 1115, reverse differentiation is performed. At step 1120, it is determined whether or not Flag=0. If so, then the method proceeds to step 1125. Otherwise, the method proceeds to step 1130. At step 1125, the coordinate sequence is output. At step 1130, a low-res block identification is performed. At step 1135, false positive are removed. At step 1140, the coordinate sequence is output.

Continuing to refer to FIG. 11, the block coordinates instead of the pixel coordinates are used for sending the block coordinates to the decoder side. If there are M blocks in the frame, then the coordinate number should range from 1 to M. Furthermore, if there is no dependency of the blocks during the restoration process, the coordinate numbers of the blocks can be sorted to make them an increasing number sequence, use a differential coding scheme to first compute the difference between a coordinate number to its previous number, and encode the difference sequence. For example, presuming the coordinate sequence is 3, 4, 5, 8, 13, 14, the differentiated sequence becomes 3, 1, 1, 3, 5, 1. The differentiation process makes the numbers closer to 1, thus resulting in a number distribution with smaller entropy. If the data have smaller entropy, then the data can be encoded with smaller code lengths according to information theory. The resulting differentiated sequence can be further encoded by lossless compression scheme, such as Huffman code. If there is dependency of the blocks during the restoration process, the differentiation process can be simply skipped. Whether or not there is block dependency is actually determined by the nature of the restoration algorithm.

During the metadata decoding process, the decoder side processor will first run the low-res block identification process using the received threshold. According to the received “flag” segment, the metadata decoding process determines whether or not the following sequence is a false positive block sequence or pruned block sequence. If there is no dependency of the blocks during the restoration process, then the following sequence will be first reverse differentiated to generate a coordinate sequence. If, according to the “flag”, the sequence is the coordinates of the pruned block sequence, then the process directly outputs the sequence as the result. If it is a false positive sequence, then the decoder side process will first take the resulting block sequence identified by the low-res block identification process, and then remove all the coordinates included in the false positive sequence.

It is to be appreciated that a different metadata encoding scheme can be used such as, for example, directly sending the block IDs to the decoder side. These and other variations are readily contemplated by one of ordinary skill in the art given the teachings of the present principles provided herein.

### Restoration Process

The restoration process is performed after the pruned video is decoded. Before restoration, the positions of the pruned blocks are obtained by decoding the metadata as described herein.

For each block, restoration process is performed to recover the content in the pruned block. Various algorithms can be used for restoration. One example of restoration is image inpainting, which restores the missing pixels in an image by interpolating from neighboring pixels. In our proposed approach, since each pruned block is replaced by low-res blocks or flat blocks, and the information conveyed by the low-res blocks or flat blocks can be used as side information to facilitate the recovery process, so that more recovery accuracy can be achieved. The block recovery module can be replaced by any recovery scheme, such as the traditional inpainting and texture synthesis based methods. Turning to FIG. 12, an exemplary block ID is indicated generally by the reference numeral 1200.

These and other features and advantages of the present principles may be readily ascertained by one of ordinary skill in the pertinent art based on the teachings herein. It is to be understood that the teachings of the present principles may be implemented in various forms of hardware, software, firmware, special purpose processors, or combinations thereof.

Most preferably, the teachings of the present principles are implemented as a combination of hardware and software. Moreover, the software may be implemented as an application program tangibly embodied on a program storage unit. The application program may be uploaded to, and executed by, a machine comprising any suitable architecture. Preferably, the machine is implemented on a computer platform having hardware such as one or more central processing units (“CPU”), a random access memory (“RAM”), and input/output (“I/O”) interfaces. The computer platform may also include an operating system and microinstruction code. The various processes and functions described herein may be either part of the microinstruction code or part of the application program, or any combination thereof, which may be executed by a CPU. In addition, various other peripheral units may be connected to the computer platform such as an additional data storage unit and a printing unit.

It is to be further understood that, because some of the constituent system components and methods depicted in the accompanying drawings are preferably implemented in software, the actual connections between the system components or the process function blocks may differ depending upon the manner in which the present principles are programmed. Given the teachings herein, one of ordinary skill in the pertinent art will be able to contemplate these and similar implementations or configurations of the present principles.

Although the illustrative embodiments have been described herein with reference to the accompanying drawings, it is to be understood that the present principles is not limited to those precise embodiments, and that various changes and modifications may be effected therein by one of ordinary skill in the pertinent art without departing from the scope or spirit of the present principles. All such changes and modifications are intended to be included within the scope of the present principles as set forth in the appended claims.

1. An apparatus for encoding a picture in a video sequence, comprising:
a pruning block identifier for identifying one or more original blocks to be pruned from an original version of said picture;
a block replacer for generating a pruned version of said picture by respectively generating one or more replacement blocks for said one or more original blocks to be pruned;
a metadata generator for generating metadata for recovering said pruned version of said picture, said metadata including position information of said one or more replacement blocks; and
an encoder for encoding said pruned version of said picture and said metadata.

2. The apparatus of claim 1, wherein said pruned version of said picture is generated by dividing said original version of said picture into a plurality of blocks, and respectively replacing said one or more original blocks to be pruned with said one or more replacement blocks, wherein all pixels in at least a given one of said one or more replacement blocks have one of a same color value or a lower resolution, said lower resolution being determined with respect to said one or more original blocks to be pruned.

3. The apparatus of claim 2, wherein said same color value is equal to an average of color values of said pixels within said at least one of said plurality of blocks.

4. The apparatus of claim 2, wherein said pruned version of said picture is a mixed-resolution picture.

5. The apparatus of claim 2, wherein said one or more pruned blocks comprise less information above a specified frequency than respective ones of said one or more original blocks to be pruned.

6. The apparatus of claim 1, wherein said position information comprises coordinate information for said one or more replacement blocks.

7. The apparatus of claim 1, wherein said pruning block identifier performs an identification process to identify said one or more original blocks to be pruned from said original version of said picture, wherein a given one of said one or more original blocks to be pruned is identified by said identification process based an amount of energy of a signal component of said given one of said one or more original blocks to be pruned larger than a specified frequency.

8. The apparatus of claim 7, wherein said metadata also includes position information of false positive blocks and missed blocks with respect to said identification process.

9. A method for encoding a picture in a video sequence, comprising:
identifying one or more original blocks to be pruned from an original version of said picture;
generating a pruned version of said picture by respectively generating one or more replacement blocks for said one or more original blocks to be pruned;
generating metadata for recovering said pruned version of said picture, said metadata including position information of said one or more replacement blocks; and
encoding said pruned version of said picture and said metadata using at least one encoder.

10. The method of claim 9, wherein said pruned version of said picture is generated by dividing said original version of said picture into a plurality of blocks, and respectively replacing said one or more original blocks to be pruned with said one or more replacement blocks, wherein all pixels in at least a given one of said one or more replacement blocks have one of a same color value or a lower resolution, said lower resolution being determined with respect to said one or more original blocks to be pruned.

11. The method of claim 10, wherein said same color value is equal to an average of color values of said pixels within said at least one of said plurality of blocks.

12. The method of claim 10, wherein said pruned version of said picture is a mixed-resolution picture

13. The method of claim 10, wherein said one or more pruned blocks comprise less information above a specified frequency than respective ones of said one or more original blocks to be pruned.

14. The method of claim 9, wherein said position information comprises coordinate information for said one or more replacement blocks.

15. The method of claim 9, wherein said step of identifying said one or more original blocks to be pruned comprises performing an identification process to identify said one or more original blocks to be pruned from said original version of said picture, wherein a given one of said one or more original blocks to be pruned is identified by said identification process based an amount of energy of a signal component of said given one of said one or more original blocks to be pruned larger than a specified frequency.

16. The method of claim 15, wherein said metadata also includes position information of false positive blocks and missed blocks with respect to said identification process.

17. An apparatus for encoding a picture in a video sequence, comprising:
means for identifying one or more original blocks to be pruned from an original version of said picture;
means for generating a pruned version of said picture by respectively generating one or more replacement blocks for said one or more original blocks to be pruned;
means for generating metadata for recovering said pruned version of said picture, said metadata including position information of said one or more replacement blocks; and
means for encoding said pruned version of said picture and said metadata.

18. The apparatus of claim 17, wherein said pruned version of said picture is generated by dividing said original version of said picture into a plurality of blocks, and respectively replacing said one or more original blocks to be pruned with said one or more replacement blocks, wherein all pixels in at least a given one of said one or more replacement blocks have one of a same color value or a lower resolution, said lower resolution being determined with respect to said one or more original blocks to be pruned.

19. The apparatus of claim 18, wherein said same color value is equal to an average of color values of said pixels within said at least one of said plurality of blocks.

20. The apparatus of claim 18, wherein said pruned version of said picture is a mixed-resolution picture.

21. The apparatus of claim 18, wherein said one or more pruned blocks comprise less information above a specified frequency than respective ones of said one or more original blocks to be pruned.

22. The apparatus of claim 17, wherein said position information comprises coordinate information for said one or more replacement blocks.

23. The apparatus of claim 17, wherein said means for identifying performs an identification process to identify said one or more original blocks to be pruned from said original version of said picture, wherein a given one of said one or more original blocks to be pruned is identified by said identification process based an amount of energy of a signal component of said given one of said one or more original blocks to be pruned larger than a specified frequency.

24. The apparatus of claim 23, wherein said metadata also includes position information of false positive blocks and missed blocks with respect to said identification process.
